(19) United States
(12) Patent Application Publication
(10) Pub. No.: US 2003/0124247 A1
(43) Pub. Date: Jul. 3, 2003

(54) Method for binding phosphor particles in a field emission display device

(75) Inventors: Robert Rasmussen, Boise, ID (US); Jianping P. Yang, Boise, ID (US)

Correspondence Address: George J. Oehling, WILLIAMS, MORGAN & AMERSON, P.C., Suite 1100, 10333 Richmond Avenue, Houston, TX, 77042, US

(73) Assignee: Micron Technology, Inc.

(21) Appl. No.: 10/331,716

(22) Filed: Dec. 30, 2002

Related U.S. Application Data
(62) Division of application No. 09/589,055, filed on Jun. 7, 2000.

(51) Int. Cl. D06L 3/12; B05B 5/00; B05D 3/02; B05D 1/18; B32B 9/00

(52) U.S. Cl. 427/157; 427/180; 427/430.1; 427/397.8; 428/704

(57) ABSTRACT

A method is provided for binding phosphor particles in a field emission device. The method includes applying phosphor particles to a substrate, submerging the substrate into a binder solution, and removing the substrate from the binder solution at a predetermined rate.

### BACKGROUND OF THE INVENTION

1. Field of the Invention

This invention relates generally to flat panel displays, and, more particularly, to a method for binding phosphor particles in a flat panel display, such as a field emission display (FED) device.

2. Description of the Related Art

Flat panel displays are becoming increasingly popular for visually displaying information generated by computers and other electronic devices. Currently, all notebook computers and an increasing number of desktop computers are using the flat panel display technology. These displays are typically lighter, consume less desktop real estate, and require less power than conventional cathode ray tube (CRT) displays. One popular type of flat panel display is the cold cathode field emission display (FED).

A field emission display uses electron emissions to illuminate a luminescent display screen and generate a visual image. An individual field emission pixel typically includes a faceplate, having the display screen formed thereon, and emitter sites formed on a base plate. The base plate includes circuitry and devices that control electron emission from the emitter sites. For example, a gate electrode structure, or grid, is associated with the emitter sites. When a voltage differential is established between the emitter sites and the grid, electron emission is initiated. The emitted electrons pass through an evacuated space and strike phosphor particles contained on the display screen. The phosphor particles are excited to a higher energy level and release photons to form an image on the display screen.

The phosphor particles on the faceplate are typically bound together with a binder material, as well as bound to the faceplate, to prevent the phosphor particles from becoming scattered as a result of the bombardment of electrons emitted from the emitters. The binder material, which typically includes potassium silicate, is dissolved in water to form a binder solution that is applied to the faceplate. Generally, if the phosphor particles are not adequately. bound together, the particles will shed from the faceplate, thereby adversely affecting the operation of the display.

Currently, two processes for applying the binder solution to the faceplate are known. In accordance with one process, the binder solution is sprayed onto the faceplate to bind the phosphor particles thereon. Another process, known as the “spinning method,” applies the binder solution to the surface of the faceplate by spinning the faceplate horizontally on a turntable. A small amount of binder solution is poured onto the faceplate initially, and spinning the faceplate distributes the solution over the faceplate's surface.

These processes, although they apply the binder solution to the faceplate, have some shortcomings. For example, when using the spray method, the binder solution often causes the hose of the sprayer to become clogged, which prevents the sprayer from applying the binder solution in a steady stream. As a result, the binder solution may not be evenly applied to the faceplate, thereby causing the binding action of the phosphor particles to be too weak on some areas of the faceplate and too concentrated in other areas or to cause visible blemishes.

The spinning method for applying the binder solution also suffers from drawbacks. Similar to the spray method, the spinning method also may not apply the binder solution evenly on the faceplate. Additionally, the spinning method becomes less effective as the size of the faceplate increases, and is typically only effective for faceplates up to five inches square. Accordingly, with the consumer's desire for larger display screens on the order of seventeen inches or more, the spinning method is not a viable option for applying the binder solution.

The present invention is directed to overcoming, or at least reducing the effects of, one or more of the problems set forth above.

### SUMMARY OF THE INVENTION

In one aspect of the present invention, a method is provided. The method includes applying phosphor particles to a substrate; submerging the substrate into a binder solution; and removing the substrate from the binder solution at a predetermined rate.

In another aspect of the present invention, a phosphor particle bounded substrate is provided. The substrate is formed by a method comprising applying phosphor particles to the substrate; submerging the substrate into a binder solution; and removing the substrate from the binder solution at a predetermined rate.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 schematically illustrates a field emmision display (FED) that includes a faceplate manufactured according to one embodiment of the present invention;

FIG. 2 illustrates a system of processes for binding phosphor particles on the faceplate of FIG. 1; and

FIG. 3 illustrates a flow chart for a method for binding phosphor particles to the faceplate of FIG. I according to one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

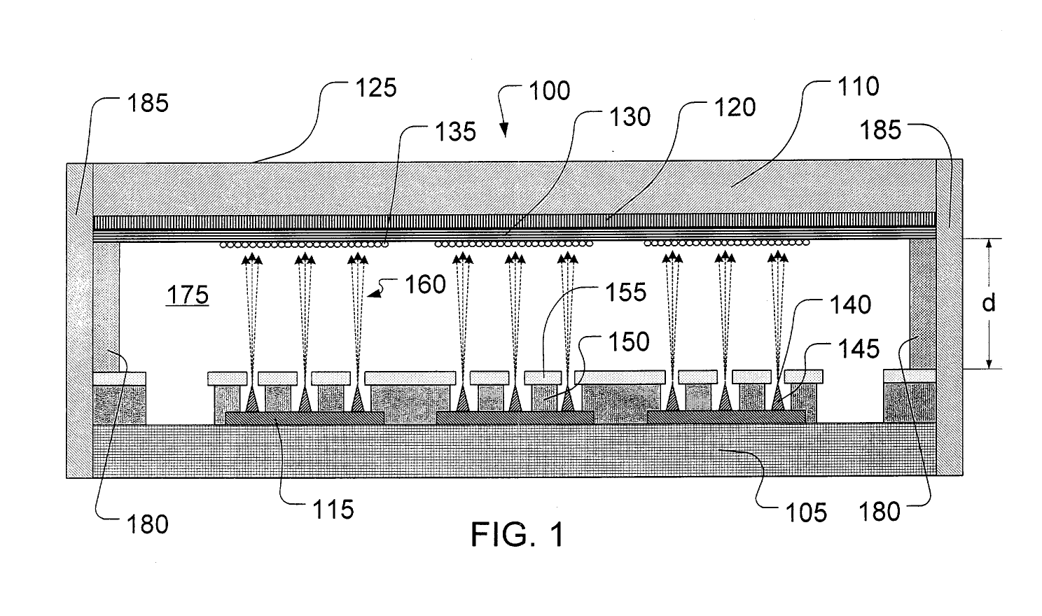

Turning now to the drawings, and specifically referring to FIG. 1, a field emission display (FED) 100 is schematically illustrated. The FED 100 includes a base plate 105 and a faceplate 110 opposite the base plate 105. In accordance with one embodiment, the base plate 105 and the faceplate 110 are glass substrates. The base plate 105 includes a plurality of cathode electrodes 115 disposed thereon, which are formed in a plurality of strips on the surface of the base plate 105. The faceplate 110 includes an anode electrode 120 that comprises a continuous layer of indium-tin-oxide or tin oxide.

The anode electrode 120 is formed on the surface opposite the viewing surface 125 on the faceplate 110, and may be made of indium oxide, tin oxide, indium-tin-oxide (ITO), or the like, which are transparent, conductive materials. Phosphor particles layer 135 is deposited on the anode electrode 120 of the faceplate 110.

The base plate 105 appears behind the faceplate 110, away from the viewing surface 125. Although the base plate 105 is constructed of glass in the illustrated embodiment, it will be appreciated that the base plate 105 may alternatively be constructed of ceramic or a semiconducting material, if so desired. The cathode electrodes 115 formed on the base plate 105 are made of a highly doped semiconducting material such as polycrystalline silicon (polysilicon) or a conductive metal. A plurality of emitters 145 are fabricated on the cathode electrodes 115 of the base plate 105, and may be made of a metal such as molybdenum (Mo), tungsten (W), platinum (Pt), or the like. The shape of the emitters 145 is generally conical, but may take the form of an alternative shape, if so desired. The emitters 145 may be separated from one another by dielectric materials 150, and gate electrodes 155 may be deposited on the dielectric materials 150. The gate electrodes 155 control an emission current 160 emitted from the emitters 145.

The face plate 110 is attached facing the base plate 105 by spacers 180, with a desired separation distance d ranging from approximately 100 to 650 μm, so that the fluorescent material layer 130 and the emitters 145 face each other and form a main space 175. The main space 175 is sealed off by firing the FED 100 after coating both side edges of the faceplate 110 and base plate 105 with a frit seal 185.

Electrons are ejected from tips 140 of the emitters 145 that collide with the phosphor particles 135 in the fluorescent material layer 130 of the faceplate 110. This collision causes electrons in the phosphor particles 135 to become excited into higher energy levels. Light is emitted as the electrons in the phosphor particles 135 return to lower energy levels.

In accordance with one embodiment, if a negative voltage and a positive voltage are respectively applied to one of the cathode electrodes 115 of the base plate 105 and to the anode electrode 120 of the faceplate 110 by an external circuit (not shown), an electric field is established between that cathode electrode 115 and the anode electrode 120. Electrons are emitted from each of the emitters 145 where such an electric field is present, thereby forming a particular emission current 160 within the field.

Positive voltages are applied to selected ones of the gate electrodes 155 on the base plate 105 to make the emission of electrons from the corresponding emitters 145 easier. The electrons emitted from the emitters 145 are accelerated by the anode electrode 120 and collide with the phosphor particles 135 of the fluorescent material layer 130. Subsequent to the collision of these electrons with the phosphor particles 135, the fluorescent material layer 130 emits light in the appropriate pattern, thereby forming a picture viewable on the viewing surface 125.

The phosphor particles 135 on the faceplate 110 are bound together with a binder material, as well as bound to the faceplate 110, to prevent the phosphor particles 135 from becoming scattered as a result of the bombardment of electrons emitted from the emitters 145. Typically, if the phosphor particles 135 are not adequately bound together, the particles 135 will shed from the faceplate 110. FEDs, such as the one illustrated in FIG. 1, tend to be intolerant to phosphor particle shedding because such loose particles typically affect the operation of the emitters 145 on the base plate 105 upon which these particles fall.

In accordance with one embodiment of the present invention, the phosphor particles 135 are deposited on the surface of the faceplate 110 by a phosphor screening process. A binder material (not shown) is then applied to the phosphor particles 135 and the faceplate 110 to keep the phosphor particles 135 bound together on the face plate 110 when the phosphor particles 135 are bombarded by the electrons emitted from the emitters 145. In accordance with one embodiment, the binder material is potassium silicate dissolved in water to form a binder solution. The faceplate 110 is then submerged into the binder solution and removed therefrom at a slow-controlled rate. The faceplate 110 is subsequently fired to set the binder material and bind the phosphor particles 135 thereon.

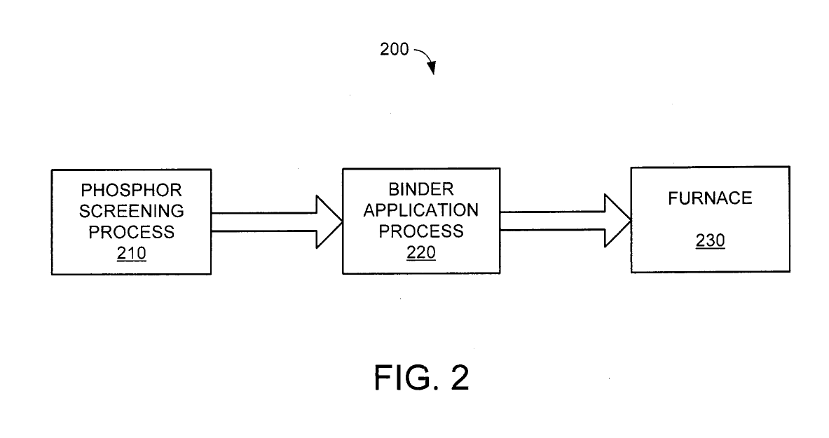

Turning now to FIG. 2, a system 200 for binding the phosphor particles 135 to the faceplate 110 is provided. The system 200 includes a phosphor screening process 210 for applying the phosphor particles 135 to the faceplate 110 by electrophoresis. It will be appreciated, however, that the adherence of phosphor particles 135 to the faceplate 110 may be accomplished via alternative methods known to those of ordinary skill in the art, such as a phosphor slurry process, dusting, electrostatic dusting, photo-tacky or settling processes. Accordingly, such process for adhering the phosphor particles 135 to the faceplate 110 need not necessarily be limited to the electrophoresis process.

The phosphor particles 135 are dispersed in a non-aqueous solution, such as isopropyl alcohol, for example. An electrolyte such as indium nitrate (0.3% by weight), for example, is also added to the solution to aid in the conductivity of the solution. Alternatively, cerium nitrate or thorium nitrate may be used in lieu thereof. Additionally, glycerol may be added to the solution (0.1-0.2% by weight), which may enhance the deposition process.

The faceplate 110 is submerged into the solution, as in a bath, for example, and a power supply (not shown) is coupled thereto. The power supply is also coupled to a counter electrode, which may be aluminum or stainless steel, for example. A voltage is applied to the faceplate 110, which causes the phosphor particles 135 to adhere to the surface of the faceplate 110 with a thickness of approximately 5-20 microns.

Subsequent to applying the phosphor particles 135 to the faceplate 110, a binder application process 220 binds the phosphor particles 135 to each other and to the faceplate 110. The faceplate 110 is lowered vertically into a binder solution for example, into a bath. In accordance with one embodiment, the binder solution is potassium silicate (approximately 0.1-2.0% by weight) dissolved in water. It will be appreciated, however, that the binder material may also include sodium silicate, organo-silicate (in alcohol), ammonium silicate, polyvinyl alcohol, or the like. Once submerged, the faceplate 110 is subsequently removed from the binder solution at a slow-controlled rate. In one embodiment, the rate at which the faceplate 110 is pulled from the binder solution is at a rate of approximately one inch per minute. It will be appreciated, however, that the rate at which the faceplate 110 is pulled from the binder solution may be slower or faster than the one inch per minute rate. The rate may be determined by drying uniformity, which may be influenced by the binder type and concentration, as well as the solvent type. The faceplate 110, subsequent to being pulled from the binder solution, is placed in a furnace 230. The faceplate 110 is heated to a temperature between about 400° and 700° C., and the binder solution is set to bind the phosphor particles 135 to one another and onto the faceplate 110.

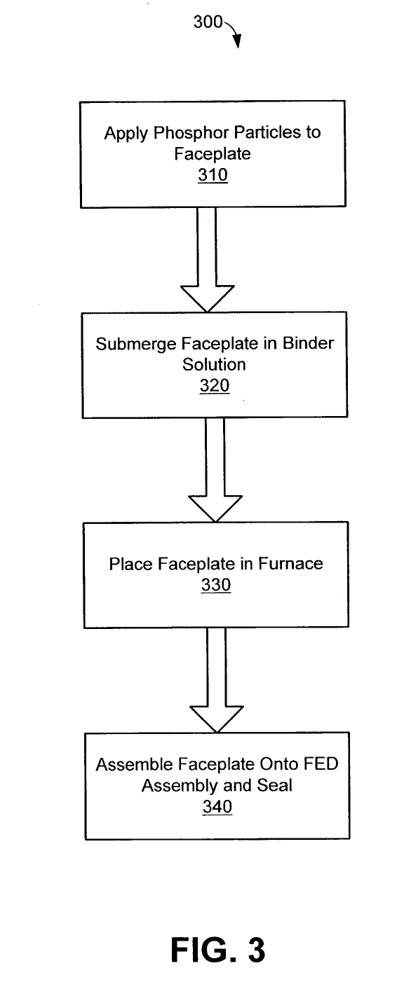

Turning now to FIG. 3, a process 300 for binding phosphor particles 135 to the faceplate 110 in accordance with one embodiment of the present invention is provided. The process 300 commences at block 310, where the phosphor particles 135 are applied to the faceplate 110 in a phosphor screening process 210 by electrophoresis, as previously discussed. It will be appreciated, however, that alternative methods known to those of ordinary skill in the art may be used in lieu of the electrophoresis process.

At block 320, the faceplate 110 is dipped vertically into a binder solution, which, in accordance with one embodiment, is potassium silicate (about 0.1-2.0% weight) dissolved in water. It will be appreciated, however, that the binder material need not necessarily be limited to potassium silicate, but may alternatively include polyvinyl alcohol, ammonium silicate, or the like. According to one embodiment, the faceplate 110 is removed from the binder solution at a slow-controlled rate, which is at a rate of approximately one inch per minute. At this slow-controlled rate, the binder solution provides a uniform distribution over the faceplate 110, thus improving the adherence of the phosphor particles 135 to each other as well as to the faceplate 110. As previously indicated, the rate at which the faceplate 110 is extracted from the binder solution may vary depending on the concentration of the solution, for example.

Subsequent to removing the faceplate 110 from the binder solution at block 320, the faceplate is placed in the furnace 230 to set the binder material and the phosphor particles 135 to the faceplate 110 at block 330, which in one embodiment is approximately 400°-700° C. More specifically, in accordance with one particular embodiment, the temperature may preferably be 400°-500° C. depending upon the type of substrate used. At block 340, the faceplate 110 is then assembled onto the base plate 105 assembly via the spacers 180 to form the FED 100 as illustrated in FIG. 1.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
applying phosphor particles to a substrate;
submerging the substrate into a binder solution; and
removing the substrate from the binder solution at a predetermined rate.

2. The method of claim 1, wherein removing the substrate from the binder solution at a predetermined rate further comprises:
removing the substrate from the binder solution at a rate of about one inch per minute.

3. The method of claim 1, further comprising:
placing the substrate into a furnace to fire the substrate.

4. The method of claim 1, wherein submerging the substrate into the binder solution, further comprises:
submerging the substrate into a solution of potassium silicate and water.

5. The method of claim 4, wherein submerging the substrate into a solution of potassium silicate and water, further comprises:
submerging the substrate into a solution of about 0.1 to 2.0% by weight of potassium silicate dissolved in water.

6. The method of claim 1, wherein submerging the substrate into the binder solution, further comprises:
submerging the substrate into a solution containing water and at least one of potassium silicate, sodium silicate, ammonium silicate and polyvinyl alcohol.

7. The method of claim 1, wherein submerging the substrate into the binder solution, further comprises:
submerging the substrate into a solution containing alcohol and organo-silicate.

8. The method of claim 3, wherein placing the substrate into a furnace to fire the substrate, further comprises:
placing the substrate into a furnace to heat the substrate to a temperature between about 400° and 700° C.

9. The method of claim 3, wherein placing the substrate into a furnace to fire the substrate, further comprises:
placing the substrate into a furnace to heat the substrate to a tempurature between about 400° and 500° C.

10. The method of claim 1, wherein applying phosphor particles to a substrate, further comprises:
submerging the substrate in a non-aqueous solution with dispersed phosphor particles.

11. The method of claim 10, wherein submerging the substrate in a non-aqueous solution with dispersed phosphor particles, further comprises:
submerging the substrate in an isopropyl alcohol solution with dispersed phosphor particles, an electrolyte and glycerol.

12. The method of claim 11, wherein submerging the substrate in an isopropyl alcohol solution with dispersed phosphor particles and an electrolyte, further comprises:
submerging the substrate in an isopropyl alcohol solution with dispersed phosphor particles and indium nitrate.

13. The method of claim 11, wherein submerging the substrate in an isopropyl alcohol solution with dispersed phosphor particles and an electrolyte, further comprises:
submerging the substrate in an isopropyl alcohol solution with dispersed phosphor particles and cerium nitrite.

14. The method of claim 11, wherein submerging the substrate in an isopropyl alcohol solution with dispersed phosphor particles and an electrolyte, further comprises:
submerging the substrate in an isopropyl alcohol solution with dispersed phosphor particles and thorium nitrate.

15. The method of claim 10, wherein submerging the substrate in a non-aqueous solution with dispersed phosphor particles, further comprises:
adding an electrolyte to the non-aqueous solution; and
applying a voltage to the substrate and a counter electrode.

16. A phosphor particle bounded substrate formed by a method comprising:
applying phosphor particles to the substrate;
submerging the substrate into a binder solution; and
removing the substrate from the binder solution at a predetermined rate.

17. The substrate of claim 16, wherein removing the substrate from the binder solution at a predetermined rate further comprises:
removing the substrate from the binder solution at a rate of about one inch per minute.

18. The substrate of claim 16, further comprising:
placing the substrate into a furnace to fire the substrate.

19. The substrate of claim 16, wherein submerging the substrate into the binder solution, further comprises:
submerging the substrate into a solution of potassium silicate and water.

20. The substrate of claim 19, wherein submerging the substrate into a solution of potassium silicate and water, further comprises:
submerging the substrate into a solution of about 0.1 to 0.5% by weight of potassium silicate dissolved in water.

21. The substrate of claim 16, wherein submerging the substrate into the binder solution, further comprises:
submerging the substrate into a solution containing water and at least one of potassium silicate, sodium silicate, ammonium silicate and polyvinyl alcohol.

22. The substrate of claim 16, wherein submerging the substrate into the binder solution, further comprises:
submerging the substrate into a solution containing alcohol and organo-silicate.

23. The substrate of claim 18, wherein placing the substrate into a furnace to fire the substrate, further comprises:
placing the substrate into a furnace to heat the substrate to a temperature between about 400° and 700° C.

24. The substrate of claim 16, where in submerging the substrate into the binder solution, further comprises:
placing the substrate into a furnace to heat the substrate to a temperature between about 400° and 500° C.

25. The substrate of claim 16, wherein applying phosphor particles to a substrate, further comprises:
submerging the substrate in a non-aqueous solution with dispersed phosphor particles.

26. The substrate of claim 25, wherein submerging the substrate in a non-aqueous solution with dispersed phosphor particles, further comprises:
submerging the substrate in an isopropyl alcohol solution with dispersed phosphor particles, an electrolyte and glycerol.

27. The substrate of claim 26, wherein submerging the substrate in an isopropyl alcohol solution with dispersed phosphor particles and an electrolyte, further comprises:
submerging the substrate in an isopropyl alcohol solution with dispersed phosphor particles and indium nitrate.

28. The substrate of claim 26, wherein submerging the substrate in an isopropyl alcohol solution with dispersed phosphor particles and an electrolyte, further comprises:
submerging the substrate in an isopropyl alcohol solution with dispersed phosphor particles and cerium nitrite.

29. The substrate of claim 26, wherein submerging the substrate in an isopropyl alcohol solution with dispersed phosphor particles and an electrolyte, further comprises:
submerging the substrate in an isopropyl alcohol solution with dispersed phosphor particles and thorium nitrite.

30. The substrate of claim 25, wherein submerging the substrate in a non-aqueous solution with dispersed phosphor particles, further comprises:
adding an electrolyte to the non-aqueous solution; and
applying a voltage to the substrate and a counter electrode.

31. A phosphor particle bounded substrate, comprising:
a substrate having first and second surfaces;
an anode electrode formed on the first surface of the substrate;
a fluorescent material layer (FML) formed on the anode electrode, the FML having phosphor particles disposed thereon;
wherein the phosphor particles are bound to the substrate by submerging the substrate into a binder solution and removing the substrate from the binder solution at a predetermined rate.

32. The phosphor particle bounded substrate of claim 31, wherein the binder solution comprises a solution of approximately 0.1%-2.0% by body weight potassium silicate in water.

33. The phosphor particle bounded substrate of claim 31, wherein the binder solution comprises water and at least one of potassium silicate, sodium silicate, ammonium silicate and polyvinyl alcohol.

34. The phosphor particle bounded substrate of claim 31, wherein the binder solution comprises alcohol and organo-silicate.

35. The phosphor particle bounded substrate of claim 31, wherein the predetermined rate is approximately one inch per minute.

36. The phosphor particle bounded substrate of claim 31, wherein the phosphor particles are bound to the substrate by submerging the substrate into a binder solution, removing the substrate from the binder solution at a predetermined rate, and placing the substrate into a furnace to heat the substrate to a temperature between about 400° and 700° C.

37. The phosphor particle bounded substrate of claim 36, wherein the substrate is heated to a temperature between about 400° and 500° C.

38. A system for binding phosphor particles to a substrate, comprising:
a first bath containing a non-aqueous solution with phosphor particles dispensed therein, the first bath for receiving the substrate to be immersed in the non-aqueous solution;
a power supply coupled to the substrate when the substrate is immersed in the non-aqueous solution, and to a counter electrode;
a binder solution;
a second bath containing the binder solution, the second bath enabling submersion of the substrate into the binder solution; and
a furnace for heating the substrate.

39. The system of claim 38, wherein the non-aqueous solution comprises phosphor and isopropyl alcohol solution and an electrolyte.

40. The system of claim 39, wherein the electrolyte comprises indium nitrate.

41. The system of claim 39, wherein the electrolyte comprises cerium nitrate.

42. The system of claim 39, wherein the electrolyte comprises thorium nitrate.

43. The system of claim 38, wherein the binder solution comprises about 0.1%-2.0% by weight potassium silicate in water.

44. The system of claim 38, wherein the binder solution comprises water and at least one of potassium silicate, sodium silicate, ammonium silicate and polyvinyl alcohol.

45. The system of claim 38, wherein the binder solution comprises alcohol and organo-silicate.

46. The system of claim 38, wherein the furnace hears the substrate to a temperature between about 400° and 700° C.

47. The system of claim 38, wherein the furnace heats the substrate to a temperature between about 400° and 500° C.
